(19) United States
(12) Patent Application Publication
(10) Pub. No.: US 2005/0001851 A1
(43) Pub. Date: Jan. 6, 2005

(54) Apparatus and method for processing annotated images

(75) Inventors: Noriyuki Okisu, Osakasayama-shi (JP); Shinichirou Noda, Sakai-shi (JP); Tsutomu Honda, Sakai-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 10/881,635

(22) Filed: Jun. 30, 2004

(30) Foreign Application Priority Data
Jul. 3, 2003 (JP) 2003-190902

(51) Int. Cl. G09G 5/00

(52) U.S. Cl. 345/619

(57) ABSTRACT

An image processing apparatus that handles images having annotations added to partial regions set within them permits efficient operation by permitting the output of, among the annotations, only those selected by the user. A personal computer sets a preview display region and an annotation selection region in a print preview window, and displays an image in the preview display region and annotations in the annotation selection region. When any of the annotations displayed in the annotation selection region is selected, this annotation is added to what is being displayed in the preview display region. When the image is printed, only the annotations displayed in the preview display region are outputted to the printer.

This application is based on Japanese Patent Application No. 2003-190902 filed on Jul. 3, 2003, the contents of which are hereby incorporated by reference.

### BACKGROUND OF THE INVENTION

1. Field of the Invention

The present invention relates to an image processing apparatus for handling images having annotations added to partial regions set within them, and relates more particularly to how to output such images and annotations to an external apparatus.

2. Description of the Prior Art

It has been proposed to add an annotation to the whole of or a partial region within an image photographed with a digital camera. This helps enhance the image's ability to convey information. Annotations can be added to images, in some cases, on the digital camera itself with which those images were photographed, or, in other cases, on a personal computer after the images have been transferred thereto. In any case, the user can set a region of a desired size in a desired position within an image and add to that region an image, a sound, a character string, or the like as an annotation.

Images and annotations can be reproduced on a digital camera or on a personal computer, and, when annotated images are outputted to a printer to produce printouts, so long as the annotations added to the images are printable images or character strings, the annotations can also be printed. Similarly, when annotated images are outputted to a device other than a printer, the annotations added to the images can also be outputted.

Personal computers can handle a large number of images. Some personal computers even have a capability of producing an index print that provides an at-a-glance overview of a plurality of images, and others a preview capability, i.e., a capability of preliminarily displaying an image in the state in which it is going to be printed. Japanese Patent Application Laid-Open No. 2000-332985 discloses a method of producing an index print wherein a layout for an index print is set automatically according to the size of a print sheet, the size of images, the number of images, and the like and a preview is displayed in that layout. On the other hand, many personal computers permit a plurality of images to be displayed in a neatly arranged fashion to permit the user to select from the so displayed images those which the user wants to print.

With respect to the output of annotations added to images, however, consideration is taken only to avoiding the output of sound annotations to a printer, and the user is not permitted to select annotations. More specifically, it is possible only to select which images to output and whether or not to output the annotations added to those annotations, and therefore, when the user chooses to output annotations, the selected images are outputted along with all the annotations added to them (except that sound annotations are not outputted to a printer).

Thus, the outputted annotations include those which the user does not want to be outputted. This results in the following problems with the conventional technology: low efficiency ascribable to the extra time and number of sheets required for the output of unnecessary annotations; and poor usability ascribable to the need to delete unnecessary annotations on a non-printer device that receives the annotations and the need to pick out, from all the printed sheets, the wanted ones. The association between images and annotations is recorded in the tag (header) of their files or in files created separately therefrom, and therefore, by modifying such records, it is possible to output only those annotations which the user wants to be outputted. However, modifying the records relating to the association between images and annotations requires some extra editing operation, resulting in poorer usability.

### SUMMARY OF THE INVENTION

An object of the present invention is to provide an efficient image processing apparatus that permits the output of, among annotations added to images, only those which the user has selected, and to provide a method for achieving that.

To achieve the above object, according to one aspect of the present invention, an image processing apparatus that is capable of processing images and annotations added to partial regions set within the images is provided with: a display; a display controller for displaying, in the same screen on the display, an image along with one or more items respectively indicating annotations added to the image; a selector for selecting, according to the operation by a user, one of the displayed items; and a controller for outputting, to an external apparatus, the displayed image along with the annotation indicated by the selected item.

With this image processing apparatus, it is possible to output an image along with only those annotations which the user has selected. This ensures time- and resource-saving, and thus efficient, operation. In addition, items indicating the annotations added to an image are displayed along with the image to permit the user select, among the displayed items, the desired ones. This ensures easy selection of annotations. The items indicating annotations may be the annotations themselves, or may be whatever else that indicates the annotations in an easy-to-recognize manner.

Annotations may each be an image, a sound, or a character string. Preferably, an item indicating an annotation is, when the annotation is an image or a character string, the image or character string itself, and, when the annotation is a sound, which cannot be displayed, the file name of the sound, for example.

The external apparatus may be a printer. In this case, when a selected annotation is a sound, the character string representing the file name of its file may be outputted.

The controller may further set, on the display, a first region in which to display the image and a second region, different from the first region, in which to display the items indicating the annotations so that, when one of the items displayed in the second region is selected by the selector, the controller displays the selected item in the first region. This makes it easy for the user to recognize what is going to be outputted.

To achieve the above objects, according to another aspect of the present invention, a method for processing images and annotations added to partial regions set within the images includes the steps of: displaying, in the same screen, an image along with one or more items respectively indicating annotations added to the image; selecting one of the displayed items; and outputting, to an external apparatus, the displayed image along with the annotation indicated by the selected item.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a diagram showing a personal computer as one embodiment of the present invention;

FIG. 2A is a perspective view showing a digital camera that feeds annotated images to the personal computer;

FIG. 2B is a rear view showing the digital camera;

FIG. 3 is a diagram showing the configuration of the windows displayed with respect to images and annotations by the personal computer;

FIG. 4 is a diagram showing an example of the index window displayed by the personal computer;

FIG. 5 is a diagram showing an example of the annotation window displayed by the personal computer;

FIG. 6 is a diagram showing an example of the print preview window displayed by the personal computer;

FIG. 7 is a flow chart showing the flow of operations performed by the personal computer to display thumbnail images;

FIG. 8 is a diagram showing the structure of file folders in the digital camera;

FIG. 9 is a flow chart showing the flow of operations performed by the personal computer to create an mdm file;

FIG. 10 is a diagram showing an example of the message displayed by the personal computer after the creation of an mdm file;

FIG. 11 is a diagram showing an example of the warning message displayed by the personal computer on failure to create an mdm file;

FIG. 12 is a flow chart showing another flow of operations performed by the personal computer to create an mdm file;

FIG. 13 is a diagram showing an example of the message displayed by the personal computer before the creation of an mdm file;

FIG. 14 is a diagram showing an example of a printout produced by the personal computer;

FIG. 15 is a flow chart showing the flow of operations performed by the personal computer to permit the selection of an annotation to be printed;

FIGS. 16A to 16E are diagrams showing examples of apparatuses that output images and annotations, examples of apparatuses that receive their output, and examples of methods for transferring the output; and

FIG. 17 is a diagram showing a screen displayed on a digital camera to permit the selection of an annotation to be transmitted.

### DESCRIPTION OF THE PREFERRED EMBODIMENTS

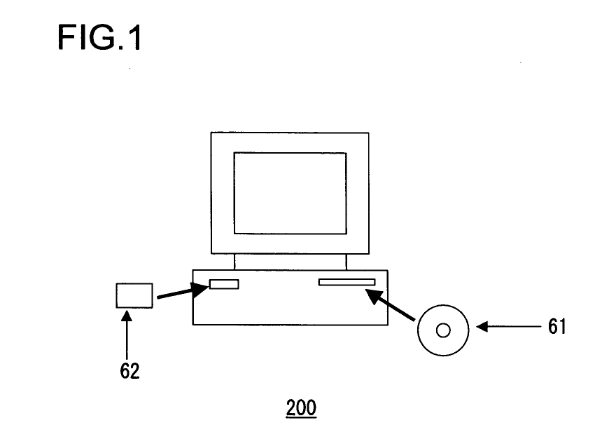

Hereinafter, an embodiment of the present invention will be described with reference to the accompanying drawings. FIG. 1 shows a personal computer 200 as one embodiment of the invention. The personal computer 200 is composed mainly of a main unit, which incorporates a CPU, a hard disk, and other components, and a display placed on top of it, and is further provided with a keyboard and a mouse (neither is illustrated). The personal computer 200 can be connected to a printer. The main unit permits an optical disk 61 and a memory card 62 to be mounted thereon.

The personal computer 200 cannot photograph images, but, when fed with images having annotations added to partial regions set within them from a digital camera, the personal computer 200 can reproduce the images and annotations. The personal computer 200 also has a capability of adding an annotation to a region specified within an image by the user. An annotation may be of one of the following three types: an image, a sound, or a character string. In the following descriptions, an image used as an annotation will be referred to also as an annotation image, a sound used as an annotation as an annotation sound, and a character string used as an annotation as an annotation character string. Moreover, an image to which an annotation has already been added or is going to be added will be referred to also as a parent image.

Programs containing operations that can be performed on images and annotations are recorded on the optical disk 61, and the personal computer 200 uses the programs after copying them to the hard disk incorporated therein. The personal computer 200 receives images and annotations in a form recorded on the memory card 62, or by way of a cable that connects the digital camera and the personal computer together. It is also possible to acquire programs and images by downloading them from a Web site or as files attached to e-mail.

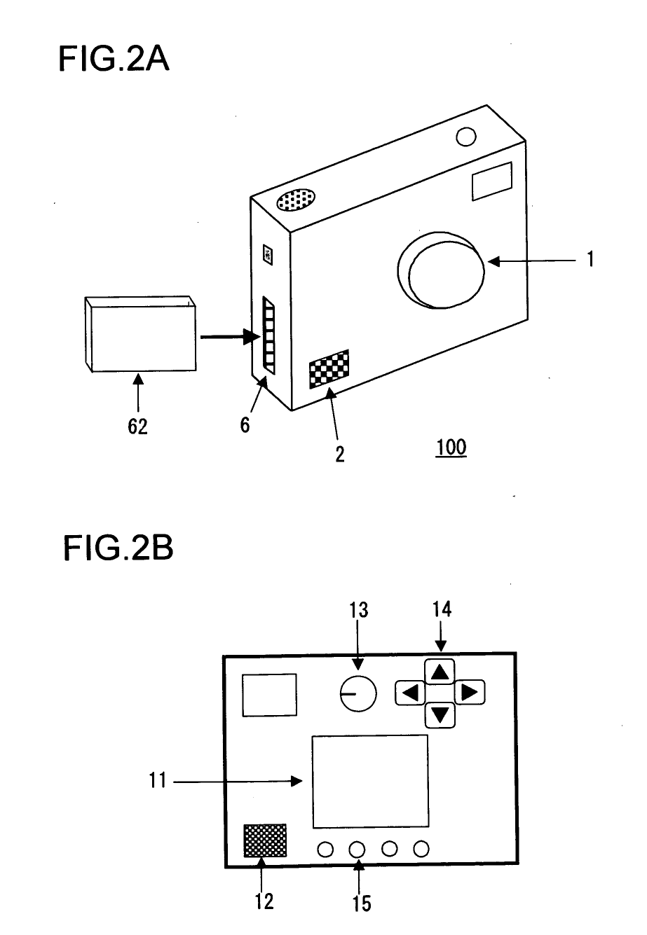

FIGS. 2A and 2B show a digital camera 100 from which the personal computer 200 is fed with images and annotations added thereto. FIGS. 2A and 2B are a perspective view and a rear view, respectively, of the digital camera 100. The digital camera 100 is provided with: on the front face, a taking lens 1 and a microphone 2; on a side face, a slot 6 in which to insert a memory card 62 incorporating a semiconductor memory; on the back face, a liquid crystal display 11, a loudspeaker 12, and various operation members 13 to 15. The digital camera 100 incorporates a CCD area sensor, and photographs an image by imaging the light from a photographing subject on the CCD sensor through the taking lens 1 and converting the thereby formed image into an electrical signal.

An annotation image or an annotation sound can be added to a region specified by the user within a photographed image. An annotation image is obtained by photographing it as any other image is. All images including annotation images can be displayed on the liquid crystal display 11. An annotation sound is sensed by the microphone 2 and is then recorded. Annotation sounds can be reproduced from the loudspeaker 12.

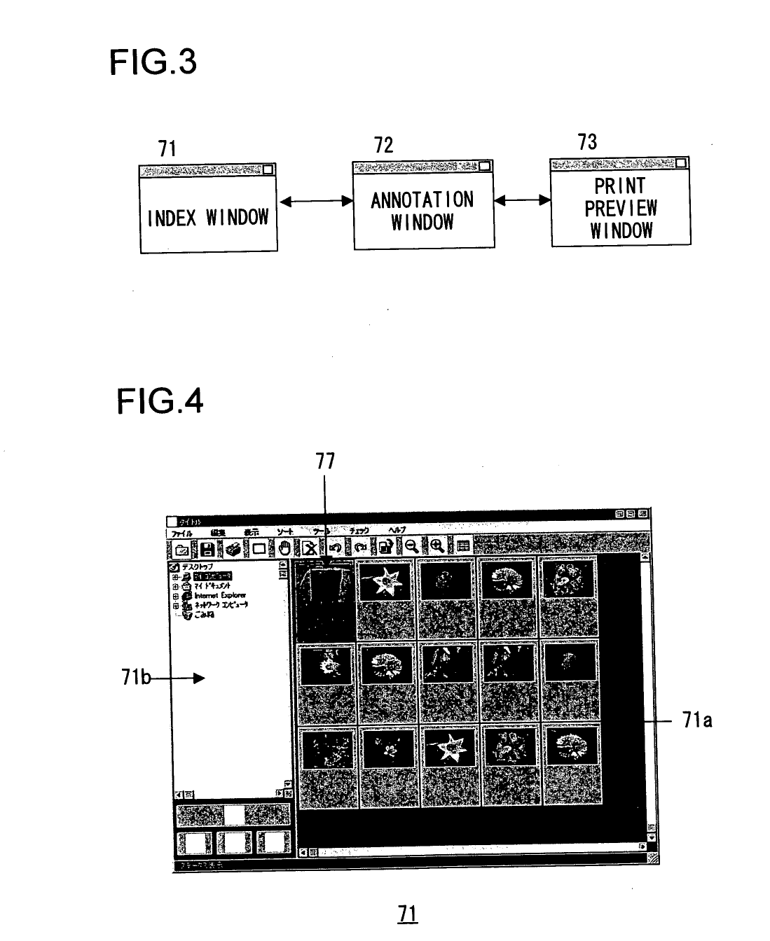

FIG. 3 shows the structure of the windows displayed on the display by the personal computer 200 with respect to images and annotations. The windows relating to images and annotations are composed of an index window 71, an annotation window 72, and a print preview window 73, which are opened as required by the operation being performed. FIGS. 4, 5, and 6 show examples of the index window 71, annotation window 72, and print preview window 73, respectively.

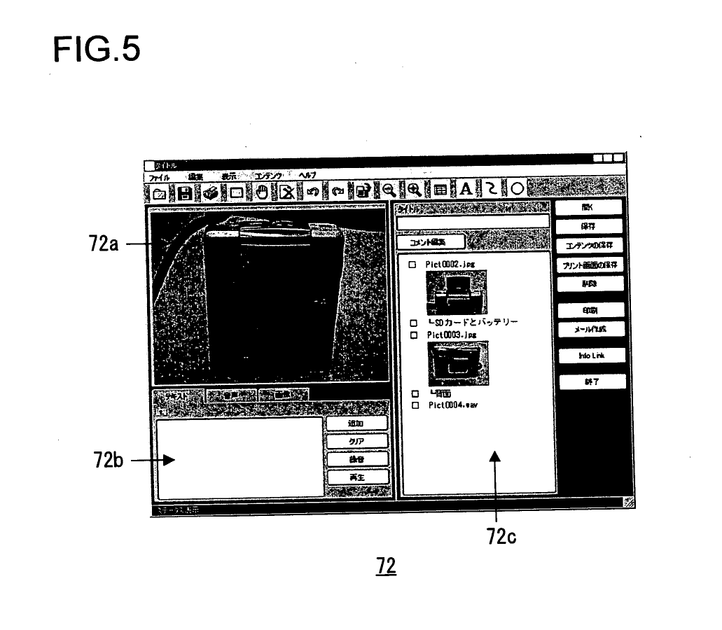

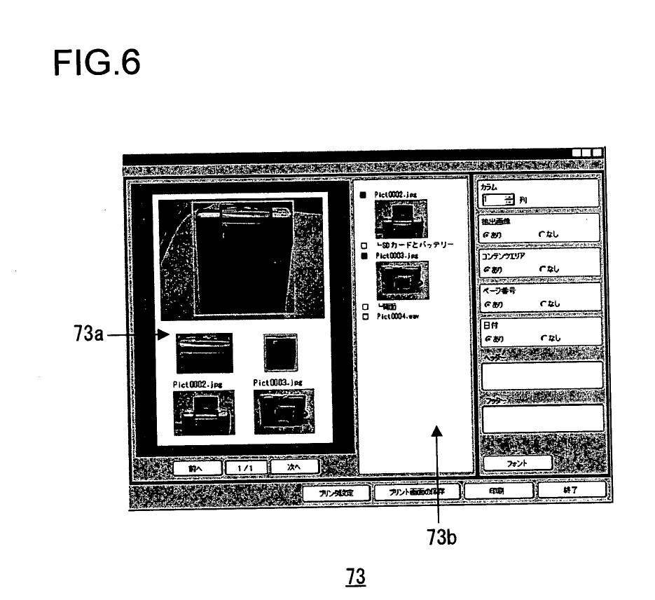

The index window 71 (FIG. 4) has a thumbnail image display region 71a and a folder tree display region 71b. The annotation window 72 (FIG. 5) has a parent image display region 72a, an annotation creation region 72b, and an annotation display region 72c. The print preview window 73 (FIG. 6) has a print preview display region 73a and a print annotation selection region 73b.

In the index window 71, thumbnail images of the image files present in the folder selected in the folder tree display region 71b are displayed in an arranged manner in the thumbnail image display region 71a. When the user selects one of the displayed thumbnail images, then selects an “add annotation” or “start reproduction” command from the menu at the top of the screen, and then executes the command, or when the user double-clicks one of the thumbnail images, the annotation window 72 opens, and the image of interest is displayed in the parent image display region 72a. FIG. 5 shows the screen displayed after the thumbnail image 77 in FIG. 4 is selected.

In the annotation window 72, it is possible to set a region within the parent image in the parent image display region 72a, and then to add an annotation to that region. An annotation is created in the annotation creation region 72b. Whereas an annotation added to an image on the digital camera 100 is either an image or a sound, an annotation character string can also be added to an image on the personal computer 200. When an annotation character string is added, the desired annotation character string is entered in the annotation creation region 72b; when an annotation image or an annotation sound is added, one of the image files and sound files displayed in the annotation creation region 72b is selected. The confirmed annotation is displayed in the annotation display region 72c.

The parent image and the annotation thus added thereto can be recorded in a file by selecting a “record” command from the menu at the top of the screen and then executing it. This file is created one for each parent file, and is a composite file that contains an image, one or more annotations, and information on the association (file names, region positions, region sizes, and other information) between the image and the annotations. In the following descriptions, such a composite file will be referred to also as an “mdm file.”

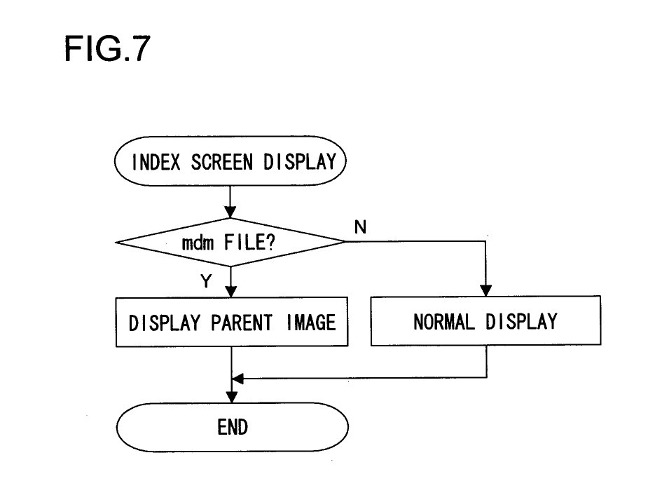

The thumbnail images displayed in the index window 71 include those for image files in ordinary formats such as JPEG, BMP, TIFF (with extensions “jpg,” “bmp,” and “tif,” respectively), and the like and those for mdm files. For ordinary image files, thumbnail images thereof are displayed; for mdm files, thumbnail images of the parent images contained therein are displayed. FIG. 7 shows the flow of operations performed to display thumbnail images.

The personal computer 200 has a capability of recording in an mdm file an image photographed with the digital camera 100 along with annotations added thereto. The digital camera 100 separately creates an image file in which a parent image is recorded and an annotation file in which an annotation is recorded, and further creates an association file in which is recorded information on the association between the parent image and all the annotations added thereto.

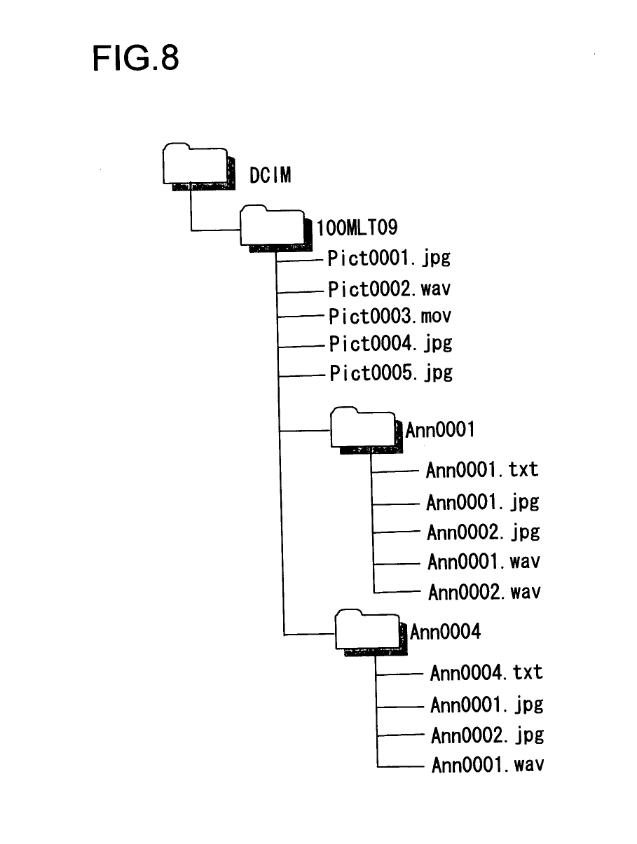

FIG. 8 shows the structure of file folders in the digital camera 100. In this example, the files named “Pict0001jpg” and “Pict0004.jpg” are parent image files. These files are stored in a DCF (Design Rule for Camera File System) folder named “100MLT09,” In this folder “100MLT09,” there exist annotation folders named “Ann0001” and “Ann004.” The numbers “0001” and “0004” in the annotation folder names are identical with the numbers in the parent image file names “Pict0001.jpg” and “Pict0004.jpg,” respectively, and this achieves association between parent files and annotation folders.

In each annotation folder, there are stored an association file and at least one annotation image file or annotation sound file. For example, in the folder “Ann0001,” there are stored an annotation file named “Ann0001.txt,” two annotation image files named “Ann0001.jpg” and “Ann0002.jpg,” and two annotation sound files named “Ann0001.wav” and “Ann0002.wav.”

Table 1 shows the contents of an association file. It should be noted that, for items Nos. 3 to 6, there exist as many sets of them as the number of annotations added to the parent image.

TABLE 1
Association File

| Item | Content |
|---|---|
| 1 | Parent image file name |
| 2 | Parent image file creation date and time |
| 3 | Annotation region position information |
| | (the coordinates of the upper left-hand corner) |
| 4 | Annotation region size information |
| | (the vertical and horizontal widths) |
| 5 | Annotation file name |
| 6 | Annotation file creation date and time |

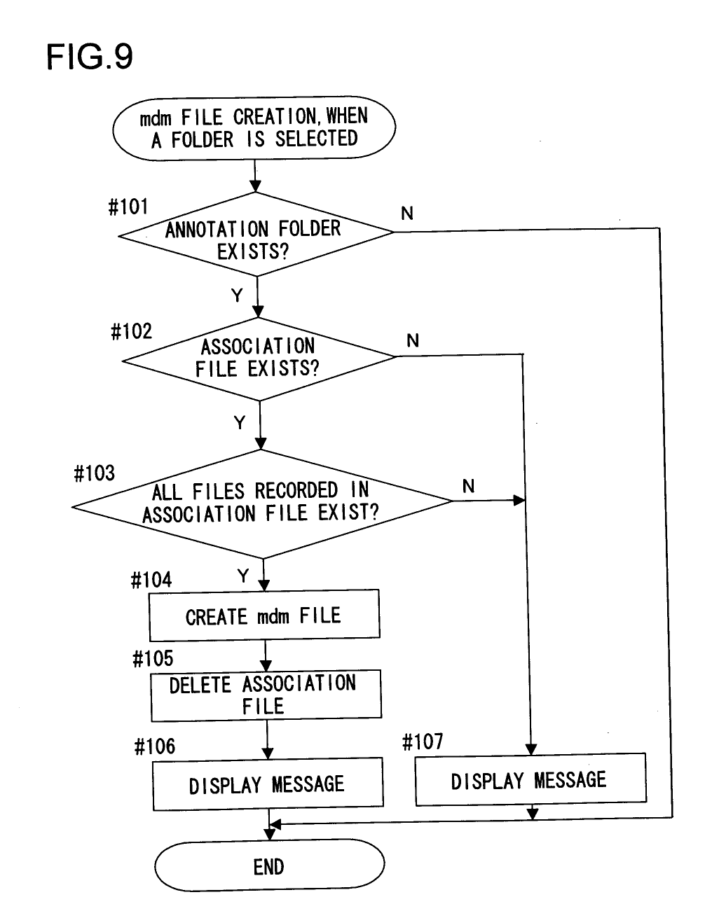

The personal computer 200 creates an mdm file by referring to the annotation folder, and the association file stored therein, that the personal computer 200 receives along with a parent image from the digital camera 100. FIG. 9 shows the flow of operations performed to create an mdm file.

An mdm file is created (step #104) only when all the following conditions are fulfilled (steps #101 to #103): an annotation folder exists immediately under the folder selected on the folder tree in the index window 71; an association file exists in that annotation folder; and all the files recorded in that association file exist in the annotation folder or in the selected folder. The reason that the selected folder is also searched here is that, as shown in FIG. 8, the parent image file corresponding to the annotation folder is stored in parallel with the annotation folder in the selected folder.

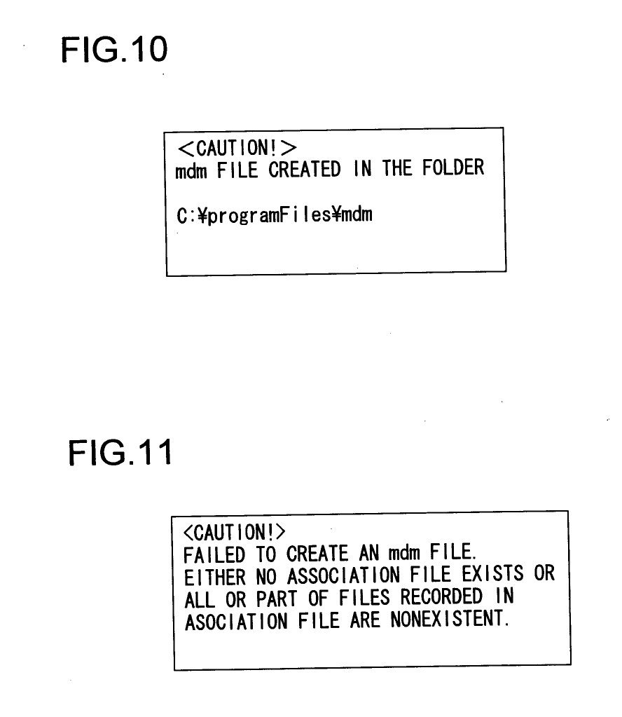

When the mdm file is created, the association file is deleted (#105). This is done to prevent creation of a new mdm file when the same folder is selected again later. Moreover, after the mdm file is created, a message, for example, as shown in FIG. 10 is displayed to indicate in which folder the created mdm file is stored (#106). If an mdm file cannot be created because, although there exists a corresponding annotation folder, no association file exists therein or any of the files recorded in the annotation file is nonexistent, a message, for example, as shown in FIG. 11 is displayed to indicate the failure (#107). If no corresponding annotation folder exists, no message is displayed. This is because, in such a case, there is no need to create an mdm file in the first place.

If, as in the example shown in FIG. 8, there exist a plurality of annotation folders in the selected folder, the operations in steps #101 to #107 are repeated for each of those annotation folders. This makes it possible to create mdm files for a plurality of image files at once. In that case, mdm files are created one for each parent image.

Through the operations described above, once a folder is specified, mdm files are created automatically. This ensures efficient operation, and also helps ease the anxiety felt by the user about inadvertently deleting files created with the digital camera 100. One disadvantage here is that mdm files are created also for those parent images for which the user do not want to create them. This can be avoided by accepting an instruction from the user as to whether to create an mdm file or not and permitting one to be created only when so instructed, or alternatively by permitting the user to specify an image file instead of a folder.

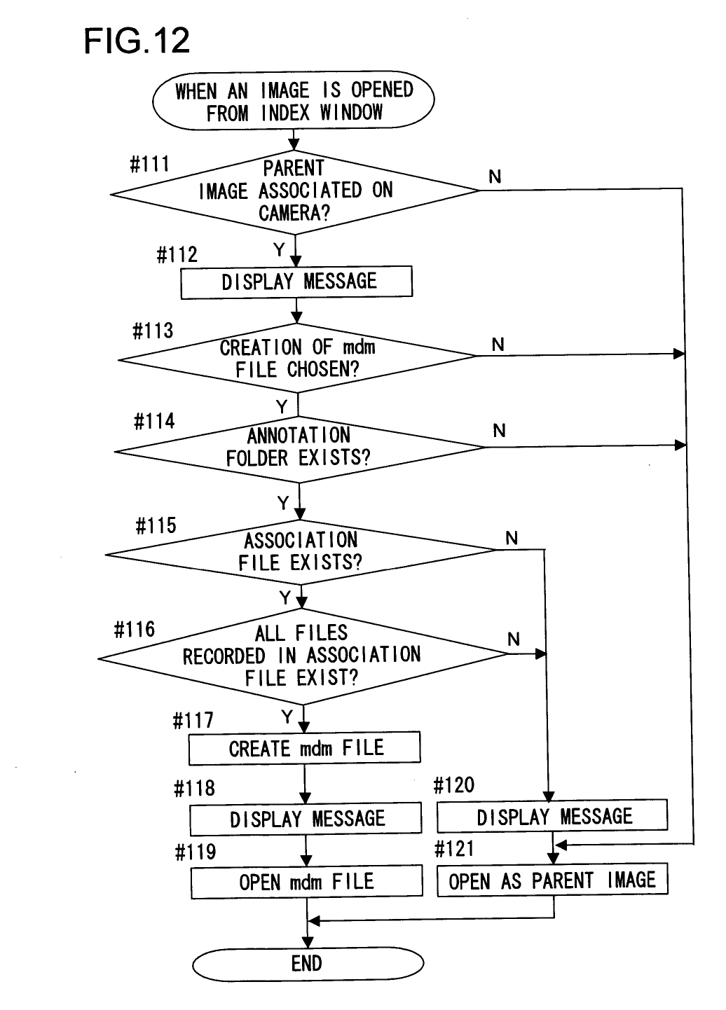

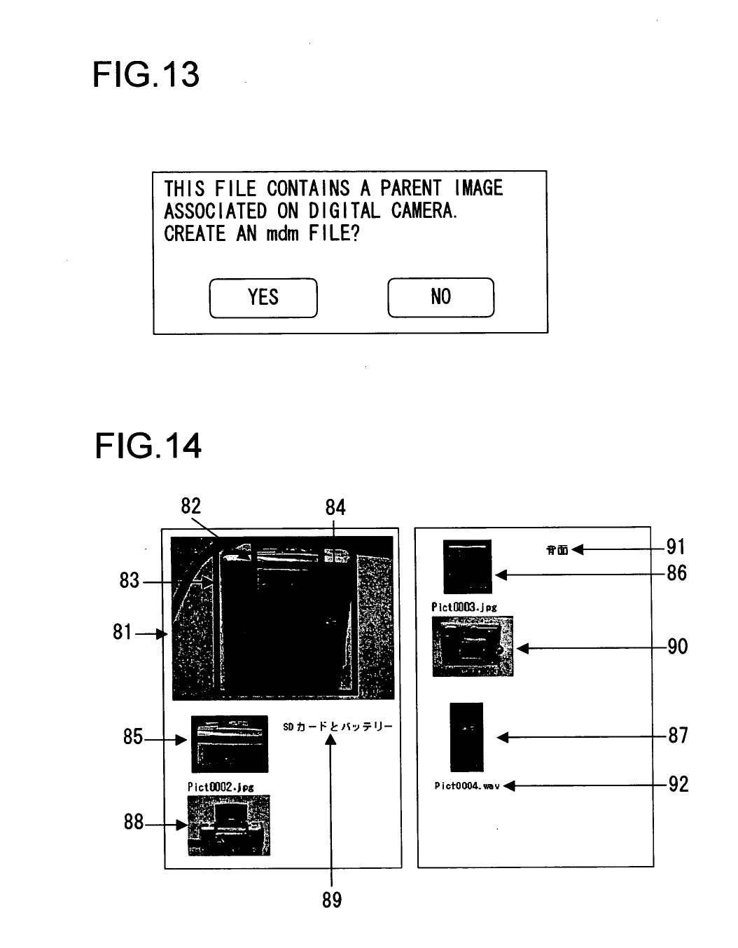

FIG. 12 shows the flow of operations performed to create an mdm file for a specified image file. When the user selects one of the thumbnail images in the index window 71, then selects an “add annotation” or “start reproduction” command from the menu, and then executes the command, or when the user double-clicks one of the thumbnail images, whether or not the image of interest is a parent image that is given any association on the digital camera 100 is checked (step #111). An image or sound file that is given any association on the digital camera 100 has information indicating its attribute, i.e., whether it contains a parent image, annotation image, annotation sound, or other content, recorded in the tag (heater) thereof. Thus, by referring to this information, it is possible to know whether a given image is a parent image or not. If the image of interest is found to be a parent image, a message, for example, as shown in FIG. 13 is displayed (#112), and then an instruction as to whether to create an mdm file or not is accepted (#113).

If the user chooses to create an mdm file, an mdm file is created (#117) in the folder where the parent image is stored only when all the following conditions are fulfilled (#114 to #116): the corresponding annotation folder exists in the folder where the parent image is stored; an association file exists in that annotation folder; and all the files recorded in the association file exist. After the mdm file is created, a message, for example, as shown in FIG. 10 is displayed to indicate in which folder the created mdm file is stored (#118). Then, the created mdm file is opened in the annotation window 72 (#119).

If an mdm file cannot be created because, although the annotation folder exists, no association file exists therein or any of the files recorded in the annotation file is nonexistent, a message, for example, as shown in FIG. 11 is displayed to indicate the failure (#120). Then, the file is opened, as a parent image to which to add a new annotation, in the annotation window 72 (#121). Also if, in step #111, the image of interest is found not to be a parent image, that file is opened, as a parent image to which to add a new annotation, in the annotation window 72.

When the user selects a “print preview” command from the menu at the top of the screen in the annotation window 72 and executes it, the print preview window 73 opens. When the user selects a “print” command from the menu at the top of the screen in the annotation window 72 or in the print preview window 73 and executes it, the image of interest is outputted to a printer so as to be printed on a print sheet.

FIG. 14 shows an example of a printout. The printout has two pages. Reference number 81 represents the parent image, and within the parent image 81 are shown regions 82, 83, and 84 to which annotations are added. Reference numbers 85, 86, and 87 are the images of the regions 82, 83, and 84, respectively (i.e., parts of the parent image). Reference numbers 88 and 89 represent the annotation image and annotation character string added to the region 82. Reference numbers 90 and 91 represent the annotation image and annotation character string added to the region 83. Reference number 92 represents the sound file of the annotation sound added to the region 84.

In this way, when printed, a parent image is shown along with the images of the regions within it to which annotations are added and the annotation images and character strings added thereto. On the personal computer 200, it is possible to select which annotations to print in the print preview window 73. As described earlier, the print preview window 73 (FIG. 6) includes the print annotation selection region 73b where all the annotations added to the parent image are displayed. Each annotation is preceded by a check box so that the user can select which annotations to print by checking (turning solid black) the corresponding check boxes. In the example shown in FIG. 6, the first and third annotations as counted from the top are selected, and those are displayed in the print preview display region 73a.

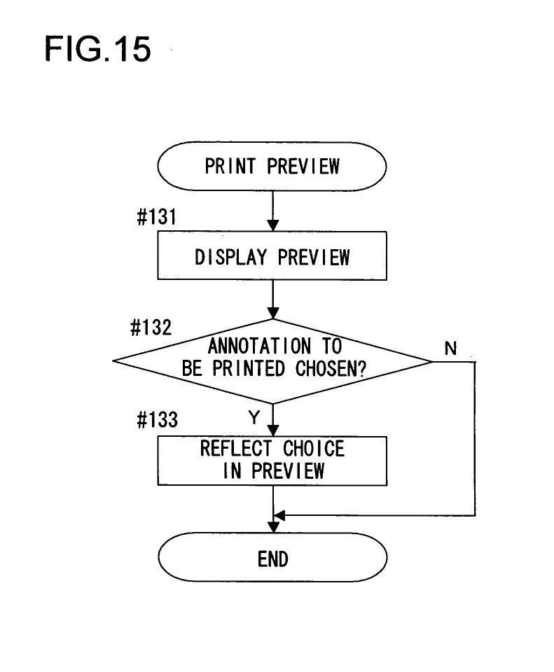

FIG. 15 shows the flow of operations performed to select an annotation to be printed. The parent image is, along with the regions within it to which annotations are added, displayed in the print preview display region 73a, and all the annotations added thereto are displayed in the print annotation selection region 73b (step #131). Then, selection of an annotation (the corresponding check box) is accepted (#132), and the selected annotation is added to what is being displayed in the print preview display region 73a (#133). When the selection of an annotation is canceled (i.e., when the check box is turned back to blank), that annotation is removed from what is being displayed in the print preview display region 73a.

In this way, the personal computer 200 permits the user to select which annotations to print as he or she likes. This ensures time- and resource-saving, and thus efficient, operation. Moreover, a parent image is displayed along with the annotations added thereto or their file names. This makes selection itself easy.

It is possible to permit the user to select which of the annotations added to a parent image not only on occasions of printing, i.e., with respect to output to a printer, but also with respect to output to any other type of device. Moreover, it is possible to permit such selection not only with respect to output from a personal computer but also to output from any other type of device, such as a digital camera, that can handle images. Furthermore, there is no restriction whatever on the method by which such output is transferred; specifically, output can be transferred by way of a cable, or wirelessly without using a cable, or in a form recorded on a recording medium.

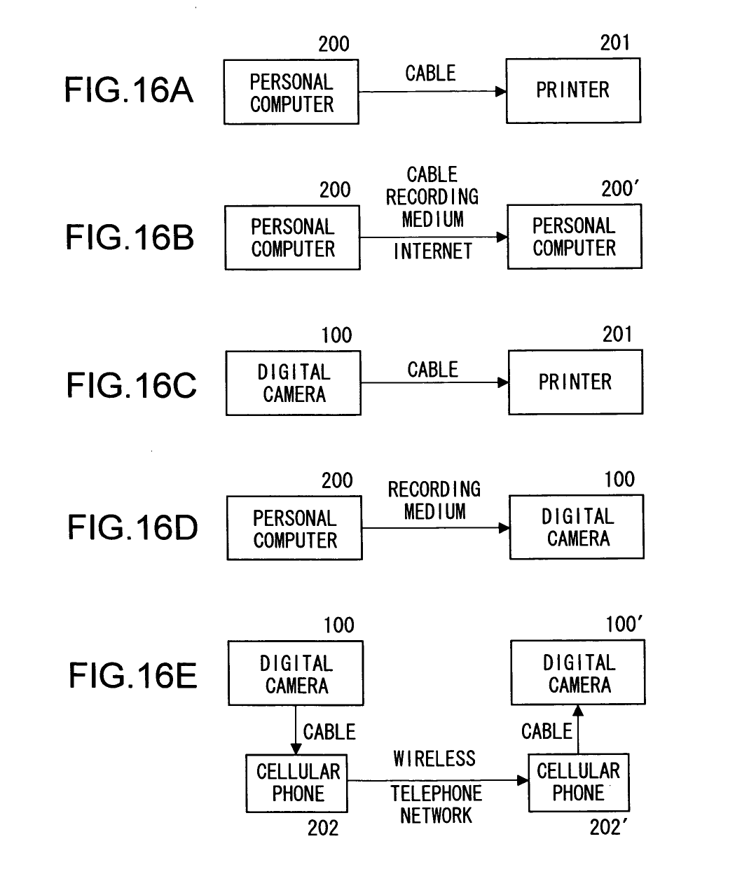

FIGS. 16A to 16E show examples of methods for transferring output from a device that outputs images and annotations to a device that receives them. FIG. 16A shows a configuration where, as in the embodiment described above, output is transferred from a personal computer 200 to a printer 201. The output is transferred by way of a cable. FIG. 16B shows a configuration where output is transferred from a personal computer 200 to another personal computer 200′. The output is transferred by way of a cable, by way of a recording medium, or over the Internet. FIG. 16C shows a configuration where output is transferred from a digital camera 100 to a printer 201. The output is transferred by way of a cable.

FIG. 16D shows a configuration in which, as opposed to the configuration of the embodiment described above, output is transferred from a personal computer 200 to a digital camera 100. The output is transferred by way of a recording medium. FIG. 16E shows a configuration where output is transferred from a digital camera 100 via cellular phones 202 and 202′ to another digital camera 100′. The output is transferred by way of a cable between the digital camera 100 and the phone 202 and between the phone 202′ and the digital camera 100′, and partly wirelessly and partly over a public telephone network between the phones 202 and 202′.

When images and annotations are outputted, they need to be converted into a format that suits the receiving device. For example, as in the examples shown in FIGS. 16A and 16C, when images and annotations are outputted to a printer, they are converted into a printable format. In this case, outputted is the parent image along with only the selected annotations and, if any of the selected annotation is a sound, the character string representing the file name of the corresponding sound file is outputted as an annotation.

When, as shown in FIG. 16B, output is transferred from a personal computer to another, relevant files may be outputted in an ordinary format such as JPEG, BMP, TIFF, or the like, or alternatively files in the mdm format may be outputted. In the former case, only the selected annotations are outputted, and in addition, as association files, those in which only the association between the parent image and the selected annotations is recorded are newly created and are outputted. In the latter case, an mdm file in which only the association between the parent image and the selected annotations is recorded is newly created and is outputted.

When, as shown in FIGS. 16D and 16E, output is transferred to a digital camera, relevant files are outputted in an ordinary format such as JPEG or the like. Also in this case, only the selected annotations are outputted, and in addition, as association files, those in which only the association between the parent image and the selected annotations is recorded are newly created and are outputted.

Now, a description will be given of an embodiment in which, as shown in FIG. 16E, images and annotations are transmitted from a digital camera 100 to another digital camera 100′. As described earlier (see FIG. 2B), the digital camera 100 is provided with, on the rear face, a liquid crystal display 11 and some operation members 13 to 15. When a main menu button provided as one element of the operation member 15 is operated, a menu is displayed in which different operation modes are displayed. In this state, when a transmission mode is selected by operating the direction keys 14, thumbnail images of the images recorded on the memory card 62 are displayed in an arranged manner, and then, when one of the thumbnail images is selected by further operating the direction keys 14, the corresponding original image is displayed.

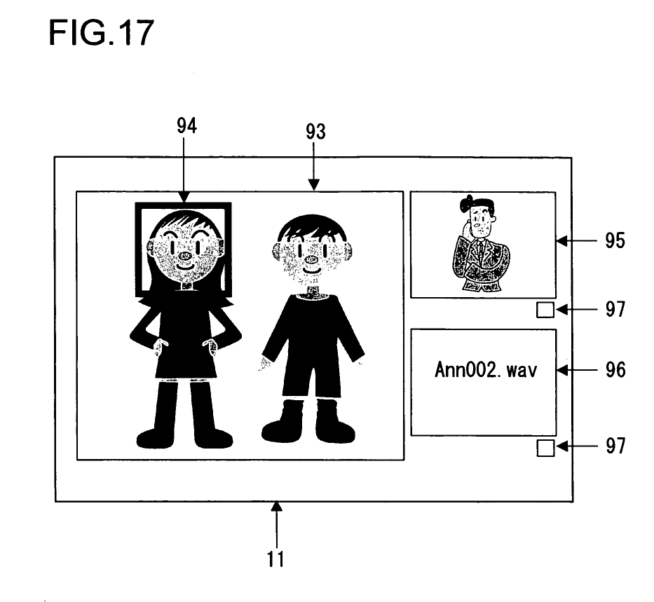

If this image is a parent image to which annotations are added, then, as shown in FIG. 17, a region frame 94 indicating the region to which the annotations are added is superimposed on the displayed parent image 93, and the annotations added thereto are also displayed by displaying, for an annotation image, the annotation image 95 itself and, for an annotation sound, the file name 96 of the corresponding sound file. Moreover, check boxes 97 are displayed near the annotations 95 and 96. The user can select which annotation to transmit by selecting (turning solid black) the corresponding check box 97 by operating the direction keys 14 and a set button provided as one element of the operation member 15. Thereafter, when a transmit button provided as one element of the operation member 15 is operated, the selected annotation is transmitted along with the parent image.

Obviously, many modifications and variations of the present invention are possible in light of the above teachings. It is therefore to be understood that within the scope of the appended claims, the invention may be practiced other than as specifically described.

1. An image processing apparatus that is capable of processing images and annotations added to partial regions set within the images, comprising:
a display;
a display controller for displaying, in a same screen on the display, an image along with one or more items respectively indicating annotations added to the image;
a selector for selecting, according to operation by a user, one of the displayed items; and
a controller for outputting, to an external apparatus, the displayed image along with the annotation indicated by the selected item.

2. An image processing apparatus as claimed in claim 1,
wherein the annotations are each an image, a sound, or a character string.

3. An image processing apparatus as claimed in claim 1,
wherein the external apparatus is a printer.

4. An image processing apparatus as claimed in claim 1,
wherein the controller further sets, on the display, a first region in which to display the image and a second region, different from the first region, in which to display the items indicating the annotations so that, when one of the items displayed in the second region is selected by the selector, the controller displays the selected item in the first region.

5. A method for processing images and annotations added to partial regions set within the images, comprising the steps of:
displaying, in a same screen, an image along with one or more items respectively indicating annotations added to the image;
selecting one of the displayed items; and
outputting, to an external apparatus, the displayed image along with the annotation indicated by the selected item.
